(19) United States
(12) Patent Application Publication
(10) Pub. No.: US 2026/0357643 A1
(43) Pub. Date: Nov. 12, 2026

(54) WINDOW STRUCTURE

(71) Applicant: SEKISUI HOUSE, LTD., Osaka-shi, Osaka (JP)

(72) Inventor: Yasuhito SUGIMURA, Osaka-shi (JP)

(73) Assignee: SEKISUI HOUSE, LTD., Osaka-shi, Osaka (JP)

(21) Appl. No.: 19/153,602

(22) PCT Filed: Oct. 23, 2023
(86) PCT No.: PCT/JP2023/038139

§ 371 Date: Aug. 5, 2025

(51) Int. Cl. E06B 3/46; E05B 65/08

(52) U.S. Cl. CPC E06B 3/4609; E05B 65/08

(57) ABSTRACT

A double window includes an outer window having outer sashes to be opened and closed by sliding, and an inner window having inner sashes to be opened and closed by sliding, the inner window being disposed on an interior side of the outer window. The outer window is provided with a crescent lock that locks the outer sashes unopenably, the crescent lock including a crescent body that is provided on a meeting stile of one of the outer sashes. The inner window is provided with an operation part that causes the crescent body to turn and that is provided on a meeting stile of one of the inner sashes opposed to the crescent body. A transmission member configured to transmit an action of the operation part to the crescent body is provided between the crescent body and the operation part.

### TECHNICAL FIELD

The present disclosure relates to a window structure provided at an opening in a building.

### BACKGROUND ART

A double window structure composed of an outer window and an inner window is one of known window structures to be provided at an opening in a building. For example, PTL 1 converts an existing single horizontal sliding sash installed in an existing opening into a double window, by fixing a new sash frame in the opening and installing a new single horizontal sliding sash in the new sash frame.

### PRIOR ART DOCUMENTS

### Patent Documents

Patent Document 1: JP 2006-118290 A

### SUMMARY OF INVENTION

### Problem to be Solved by the Invention

In this type of double window, it is troublesome to open an outer window equipped with a crescent body as a locking device. A process for opening the outer window requires opening an inner window sash maximally so as to enable a turning operation of the crescent body on the outer window, then turning the crescent body to unlock the outer window, and thereafter opening the outer window. In this respect, PTL 1 suggests linking the new single sliding sash with the existing single sliding sash that has been equipped with a crescent body, without mounting any crescent body on the new single horizontal sliding sash installed on the exterior side. For security reasons, however, it is undesirable that the outer window is not equipped with any locking device such as a crescent body.

A window structure according to the present disclosure aims to simplify an opening/closing operation for an outer window and an inner window.

### Means for Solving the Problem

A window structure according to the present disclosure includes an outer window having outer sashes to be opened and closed by sliding, and an inner window having inner sashes to be opened and closed by sliding, the inner window being disposed on an interior side of the outer window. The outer window is provided with a crescent lock that locks the outer sashes unopenably, the crescent lock including a crescent body that is capable of turning and that is provided on a meeting stile of one of the outer sashes. The inner window is provided with an operation part that causes the crescent body to turn, the operation part being provided on a meeting stile of one of the inner sashes opposed to the crescent body. A transmission member configured to transmit an action of the operation part to the crescent body is provided between the crescent body and the operation part.

Preferably, in this window structure, each of the outer sashes and an opposed one of the inner sashes disposed on an interior side of the outer sashes are linked via a linking member, and each of the outer sashes can slide in coordination with opening and closing of the opposed inner sash.

Preferably, in this window structure, the outer sashes include at least a first outer sash and a second outer sash that are disposed slidably relative to each other, the first outer sash and the second outer sash overlapping with each other at a meeting stile of the first outer sash and a meeting stile of the second outer sash, and the crescent lock is provided across the meeting stiles of the first and second outer sashes; and the inner sashes include at least a first inner sash and a second inner sash that are disposed slidably relative to each other, the first inner sash and the second inner sash overlapping with each other at a meeting stile of the first inner sash and a meeting stile of the second inner sash, and the operation part is provided on one of the meeting stiles of the first and second inner sashes.

Preferably, in this window structure, the operation part includes a slidably operable lever that is exposed to an interior side of the inner sashes, and the transmission member converts and transmits an action of the lever in a slide direction to an action of the crescent body in a turning direction.

### Advantageous Effects of Invention

The present disclosure can simplify an opening/closing operation for an outer window and an inner window.

### BRIEF DESCRIPTION OF DRAWINGS

FIG. 1 is a perspective view showing a general configuration of a window structure according to an embodiment of the present disclosure.

FIG. 2 is a vertical cross sectional view schematically showing a meeting part of an outer window and an inner window.

FIG. 3 is a vertical cross sectional view schematically showing the meeting part of the outer window and the inner window.

FIG. 4 is a transverse sectional view schematically showing the meeting part of the outer window and the inner window.

FIG. 5 is a transverse sectional view schematically showing the meeting part of the outer window and the inner window.

FIG. 6 is an explanatory view showing an operation part and a transmission member as seen from an interior side.

FIG. 7 is a schematic perspective view focusing on a configuration of the transmission member.

FIG. 8 is a schematic perspective view focusing on a configuration of the transmission member.

FIG. 9 is an enlarged perspective view of a locking part.

FIG. 10 is a partial enlarged view showing an example of a mobile piece and a ridged piece.

FIG. 11 is a front view showing an example of a window structure according to another embodiment.

FIG. 12 is a front view showing an example of a window structure according to another embodiment.

### MODE FOR CARRYING OUT THE INVENTION

A window structure according to an embodiment of the present disclosure is described with reference to the drawings.

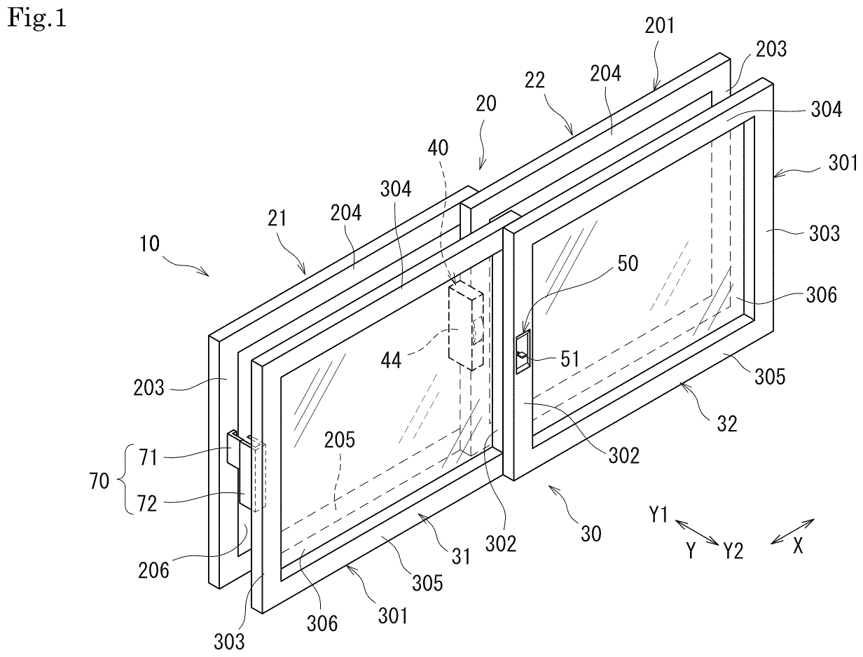

FIG. 1 is a perspective view showing a general configuration of a window structure according to an embodiment. A double window 10 is installed at an opening in a building, and has a window structure according to the present disclosure. As shown in FIG. 1, the double window 10 includes an outer window 20 to be opened and closed by sliding, and an inner window 30 to be opened and closed by sliding, the inner window 30 being disposed on an interior side of the outer window 20.

For convenience of description, FIG. 1 shows the outer window 20 and the inner window 30 in a spaced relationship, and omits a transmission member 60 (to be described later) between the outer window 20 and the inner window 30. In the following description, a face direction X indicates a surface direction across sashes of the outer window 20 and the inner window 30 (outer sashes and inner sashes), and corresponds to a width direction (a horizontal direction) in a front view of the double window 10. A depth direction Y corresponds to a direction of thickness of the outer window 20 and the inner window 30 (a depthwise direction), where Y1 indicates an exterior side and Y2 indicates an interior side. In the outer window 20 and the inner window 30, a facewise surface means each surface facing the exterior side and the interior side, and a depthwise surface means each surface extending in the depth direction Y.

### Overview of the Double Window

The double window 10 is disposed in a frame (not shown) mounted at an opening in a building. The inner window 30, disposed on the interior Y2-side, is equipped with a plurality of inner sashes (31, 32) to be opened and closed by sliding. In the double window 10 shown in FIG. 1, the inner sashes include a first inner sash 31 and a second inner sash 32 that are disposed slidably relative to each other.

Each of the first inner sash 31 and the second inner sash 32 includes stiles/rails 301 and a facing 306 such as glass placed in the stiles/rails 301. The stiles/rails 301 are composed of a meeting stile 302 and an edge stile 303 as right and left vertical components and a top rail 304 and a bottom rail 305 as top and bottom components, all of which are assembled into a rectangular frame. The first inner sash 31 and the second inner sash 32 are arranged such that, when closed, their meeting stiles 302 overlap with each other in the depth direction Y.

The outer window 20, disposed on the exterior Y1-side, is equipped with a plurality of outer sashes (21, 22) to be opened and closed by sliding, and a locking part 40 that locks these outer sashes unopenably. In the double window 10 shown in FIG. 1, the outer sashes include a first outer sash 21 and a second outer sash 22 that are disposed slidably relative to each other. Each of the first outer sash 21 and the second outer sash 22 includes stiles/rails 201 and a facing 206 such as glass fitted in the stiles/rails 201. The stiles/rails 201 are composed of a meeting stile 202 and an edge stile 203 as right and left vertical components and a top rail 204 and a bottom rail 205 as top and bottom components, all of which are assembled into a rectangular frame.

The locking part 40 is provided on the meeting stiles 202 where the first outer sash 21 and the second outer sash 22 overlap with each other in a closed state. The locking part 40 has a cover 44 to cover a crescent lock and other internal components. The cover 44 is formed, for example, in a box shape and is fixed on the meeting stile 202 of the second outer sash 22 in the outer window 20.

The outer window 20 and the inner window 30 may be installed not only during new construction of a building but also during renovation of a building. It is also possible, during renovation of a building, to convert an existing window to an outer window and to install a new inner window by attaching a frame extender or the like on the interior side of the existing window. The window structure according to the present disclosure is applicable to any of these cases.

### Linking Member

In the window structure according to the present disclosure, a linking member 70 enables coordinated opening and closing of the outer window 20 and the inner window 30. As shown in FIG. 1, the linking member 70 includes a projecting member 71 and a grooved member 72. The projecting member 71 has a portion that projects in the depth direction Y. The projecting member 71 may be, for example, a metal fitting having an L-shaped cross section. The grooved member 72 has a groove shape that opens in the depth direction Y. The grooved member 72 may be, for example, a metal fitting having a U-shaped cross section. The projecting member 71 is fitted in the grooved member 72. Preferably, a urethane or like buffer is provided inside the groove of the grooved member 72.

The projecting member 71 is attached to the first outer sash 21, on a facewise, interior Y2-side surface of the edge stile 203. The grooved member 72 is attached to the first inner sash 31 that faces the first outer sash 21, on a facewise, exterior Y1-side surface of the edge stile 303. The projecting member 71 and the grooved member 72 can be fixed by screwing or fixed adhesively on the edge stiles 203, 303.

The first inner sash 31 is installed such that the grooved member 72 is fitted with the projecting member 71 of the first outer sash 21. The first outer sash 21 and the first inner sash 31 are thereby linked via the linking member 70. This configuration makes the first outer sash 21 slidable in coordination with opening/closing movement of the first inner sash 31. When the first inner sash 31 is opened by sliding, the first outer sash 21 linked with the first inner sash 31 by the linking member 70 is also caused to slide coordinately. Although not shown, a similar linking member 70 is also provided between the second outer sash 22 and the second inner sash 32 and enables coordinated opening/closing movement of the second outer sash 22 and the second inner sash 32.

In an alternative configuration for the linking member 70, the projecting member 71 may be provided on the inner window 30, and the grooved member 72 may be provided on the outer window 20. Preferably, the projecting member 71 and the grooved member 72 are positioned substantially in a middle of the edge stiles 203, 303 in the vertical direction. This arrangement can prevent the outer sashes 21, 22 and the inner sashes 31, 32 from overturning and tilting when the sashes are opened and closed by sliding. Preferably, the projecting member 71 and the grooved member 72 are elongated members, one of which is longer than the other. For example, the grooved member 72 attached to the inner window 30 may be an elongated member that is longer in the vertical direction than the projecting member 71 attached to the outer window 20, which facilitates positioning of the grooved member 72 relative to the projecting member 71.

Note that the schematic illustration in FIG. 1 shows the outer window 20 and the inner window 30 in a spaced relationship, but the outer window 20 and the inner window 30 are installed more closely to each other.

### Locking Part

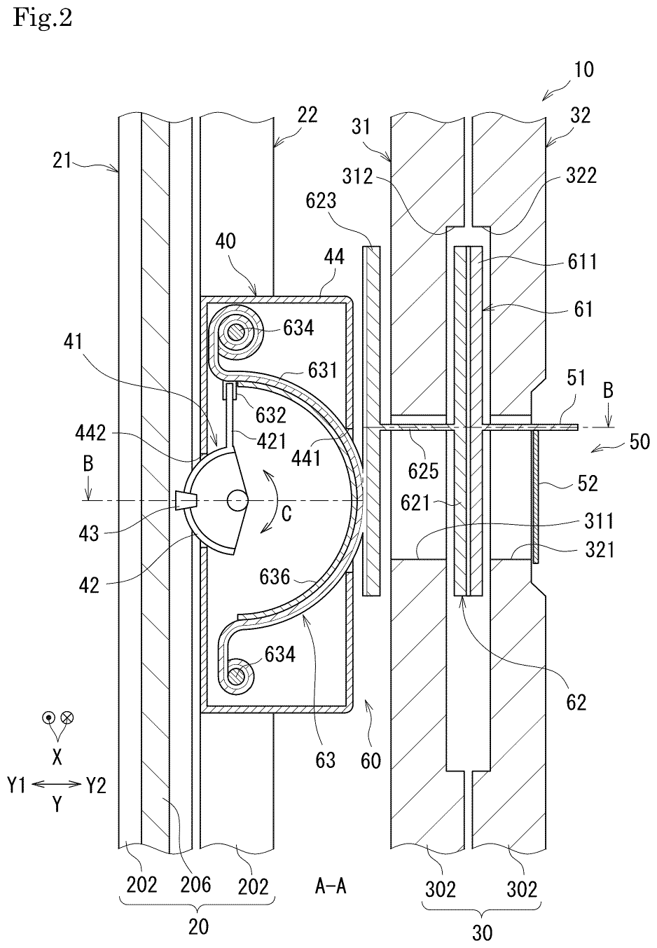

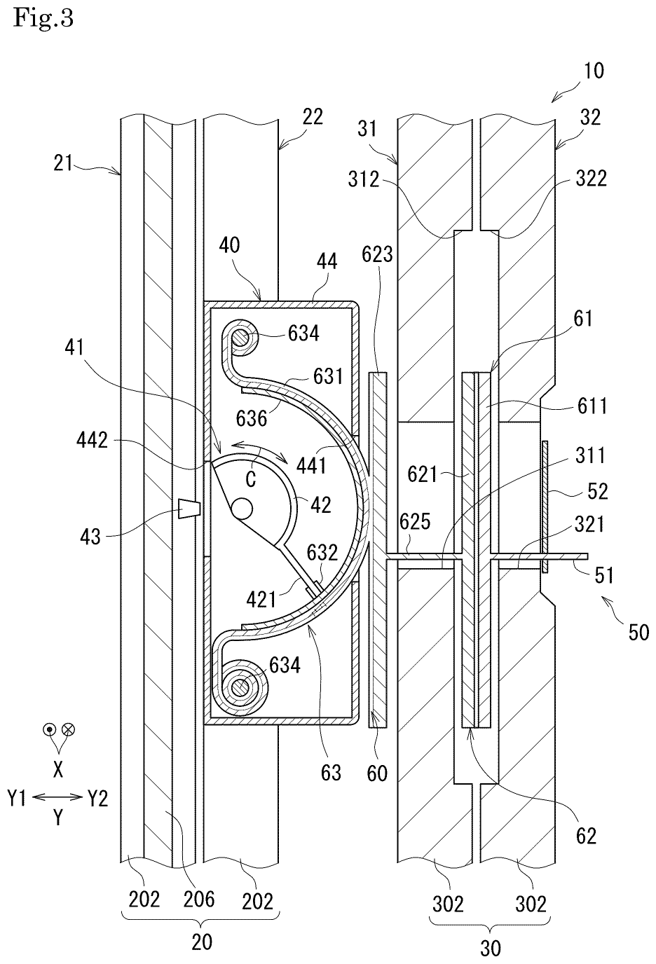

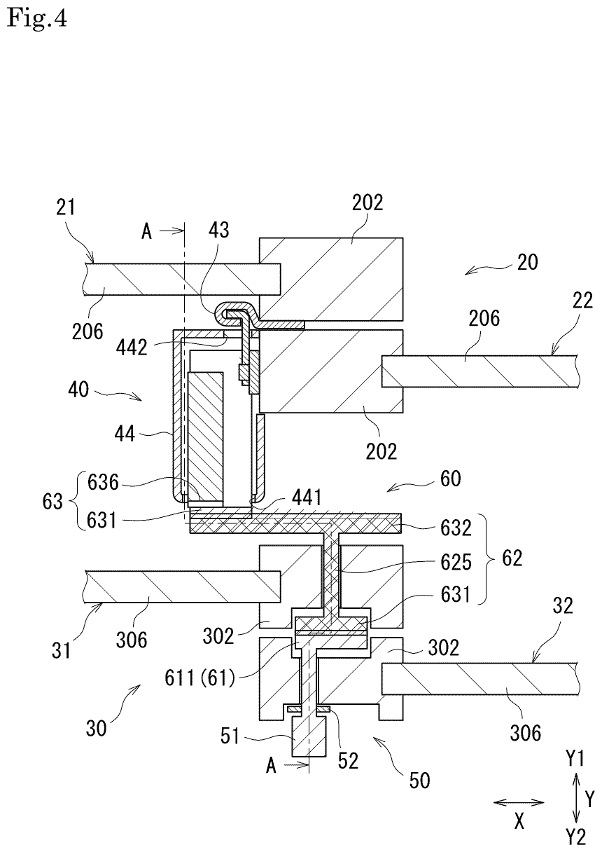

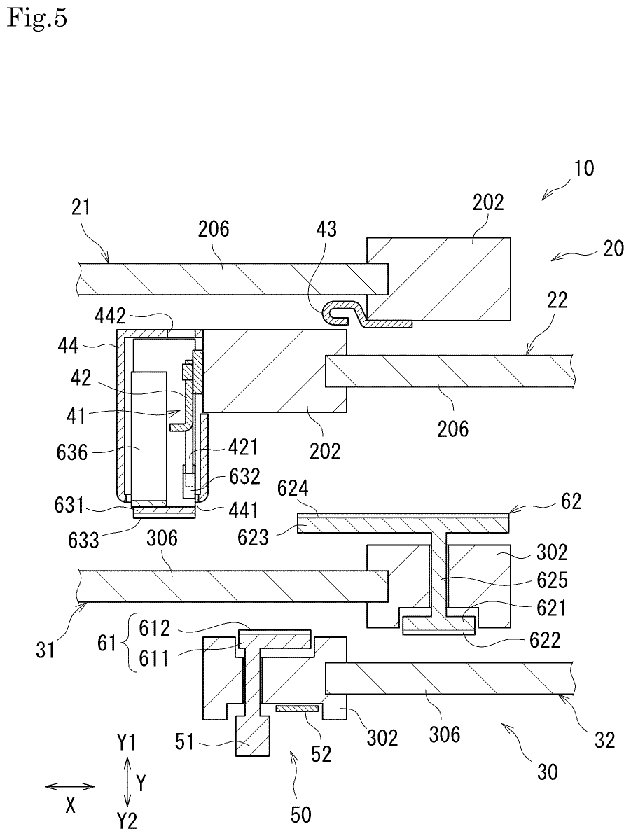

FIGS. 2 and 3 are vertical cross sectional views schematically showing the meeting part of the outer window 20 and the inner window 30. FIGS. 4 and 5 are transverse sectional views schematically showing the meeting part of the outer window 20 and the inner window 30. FIG. 2 corresponds to a cross section taken along a line A-A in FIG. 4. FIG. 4 corresponds to a cross section taken along a line B-B in FIG. 2.

In these drawings, the stiles/rails (for example, the meeting stiles 202, 302) and the facings 206, 306 that constitute the outer window 20 and the inner window 30 are shown in a simplified manner, with their specific structure being omitted. For example, the facings 206, 306 are not limited to single pane glass, but may be insulated glass or various Low-E insulated glass. The facings 206, 306 may also be composed of a resin facing such as a polystyrene resin sheet.

As a locking device for the outer window 20, the locking part 40 includes a crescent lock 41. The crescent lock 41 includes a crescent body 42 and a keeper 43. The keeper 43 is provided on the meeting stile 202 of the first outer sash 21 that constitutes the outer window 20. The crescent body 42 is provided on the meeting stile 202 of the second outer sash 22. The crescent body 42 includes a handle 421 for turning the crescent body 42, the handle 421 extending in a radial direction relative to a turning direction C. When the crescent body 42 is turned to engage with or disengage from the keeper 43, the first outer sash 21 and the second outer sash 22 can be locked unopenably or can be unlocked openably.

The crescent lock 41 is not limited to the one having the crescent body 42 and the corresponding keeper 43 of above-exemplified shapes. As far as the crescent lock is locked and unlocked by a turning action of the handle 421, the crescent lock may have any shape.

### Operation Part

As shown in FIG. 1, the inner window 30 is equipped with an operation part 50. The operation part 50 is provided on the meeting stile 302 of the inner window 30, at a position opposed to the locking part 40. In this case, the operation part 50 is provided on the interior Y2-side of the meeting stile 302 where the first inner sash 31 and the second inner sash 32 overlap with each other.

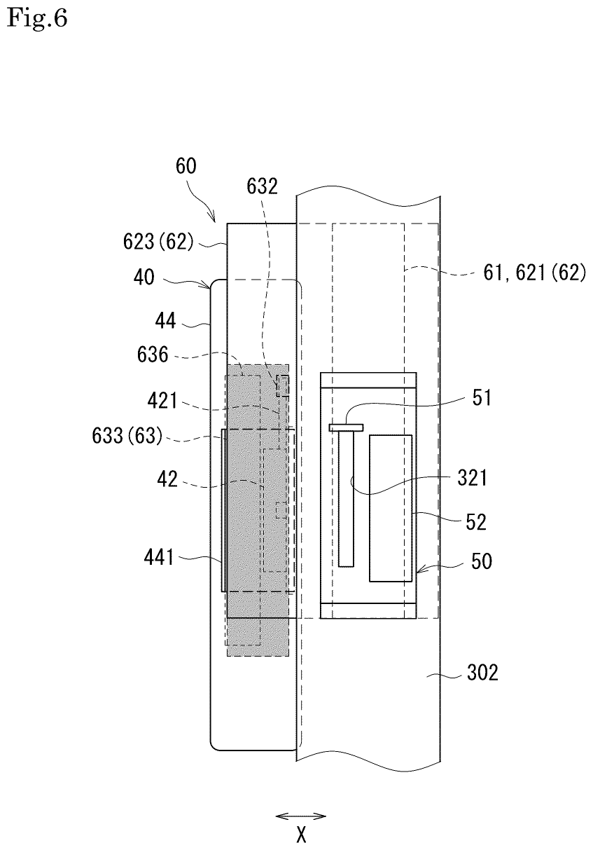

FIG. 6 is an explanatory view showing the operation part 50 as seen from the interior Y2-side. In FIG. 6, the facing 306, fitted in the meeting stile 302 and disposed in the face direction X, is omitted; an exterior-side main piece 623 and other components in a second transmission member 62 located behind the facing 306 are shown by see-through illustration; and a mobile piece 631 of a third transmission member 63 is shown in light gray.

The operation part 50 is provided on the meeting stile 302 of the second inner sash 32, and is equipped with a lever 51 that is slidable in a direction along the meeting stile 302 (for example, the vertical direction). The lever 51 can slide along a slide groove 321 formed in the meeting stile 302 of the second inner sash 32. The slide groove 321 penetrates through the meeting stile 302, and is open to the interior side and the exterior side of the meeting stile 302. An end of the lever 51 is exposed from the facewise, interior Y2-side surface of the second inner sash 32, and thus is operable from the interior Y2-side. The slide groove 321 may be sealed by a sheet that has a slit through which the lever 51 is inserted.

Preferably, a fixing member 52 is provided beside the slide groove 321. The fixing member 52 is slidable in the face direction X. The fixing member 52, positioned below the lever 51, covers the slide groove 321 and inoperably fixes the lever 51.

### Transmission Member

A transmission member 60, omitted in FIG. 1, is provided between the locking part 40 on the outer window 20 and the operation part 50 on the inner window 30. The transmission member 60 serves to transmit an action of the operation part 50 to the crescent body 42.

As shown in FIG. 2, the transmission member 60 includes a first transmission member 61 integrated with the lever 51, a second transmission member 62 engageable with and disengageable from the first transmission member 61, and a third transmission member 63 connected to the crescent body 42 and reciprocally movable in the turning direction C of the crescent body 42. The transmission member 60, by way of the first transmission member 61, the second transmission member 62, and the third transmission member 63, converts and transmits a slide action of the lever 51 to an action of the crescent body 42 in the turning direction C.

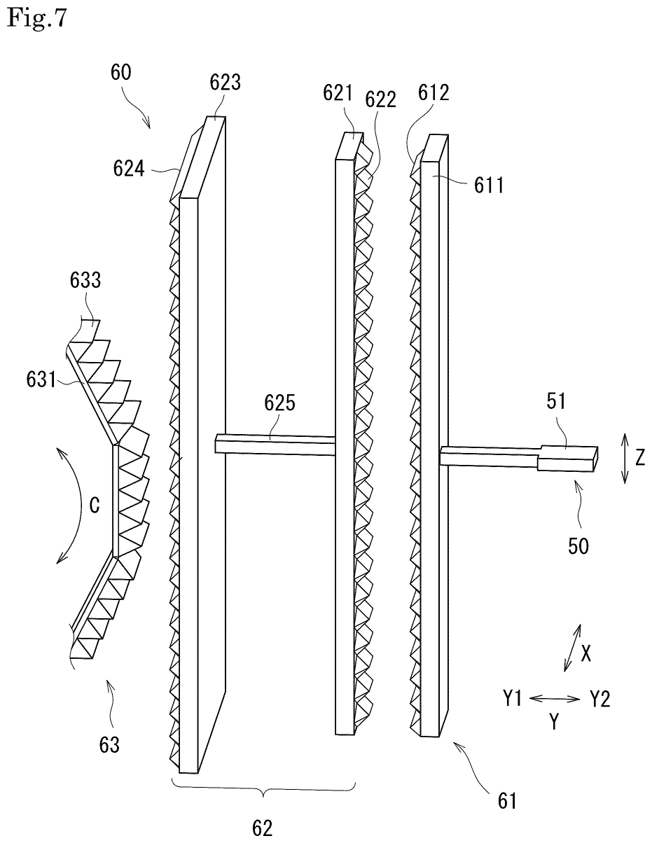

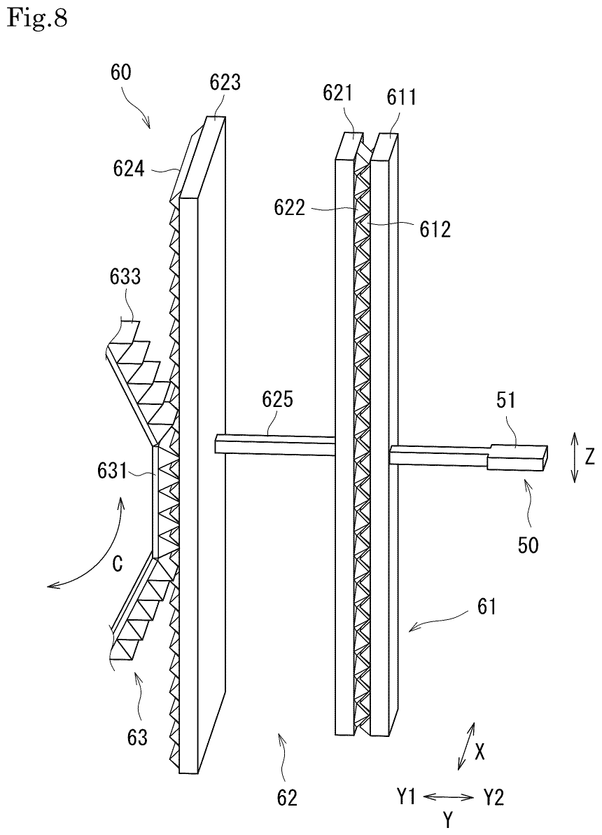

FIG. 7 is a schematic perspective view focusing on a configuration of the transmission member 60 provided in the double window 10. In FIG. 7, the components of the transmission member 60 are disengaged from each other. In FIG. 8, the components of the transmission member 60 are engaged with each other.

As shown in FIG. 7, the first transmission member 61 as the transmission member 60 is integrated with the lever 51 in the operation part 50. The first transmission member 61 includes a plate-shaped main piece 611 and a ridged piece 612 provided on an exterior Y1-side surface of the main piece 611. Longer sides of the main piece 611 are oriented in a vertical direction Z that is orthogonal to the lever 51 extending in the depth direction Y. A surface of the main piece 611 extends parallel to the face direction X.

The second transmission member 62 includes a plate-shaped interior-side main piece 621 disposed on the interior Y2-side, a plate-shaped exterior-side main piece 623 disposed on the exterior Y1-side, and a connecting piece 625 that integrally connect the two main pieces 621, 623. The interior-side main piece 621 and the exterior-side main piece 623 are opposed to each other. Longer sides of the main pieces 621, 623 are oriented in the vertical direction Z. Surfaces of the main pieces 621, 623 extend parallel to the face direction X. The connecting piece 625 extends in a direction across (for example, a direction orthogonal to) the interior-side main piece 621 and the exterior-side main piece 623. A ridged piece 622 is provided on an interior Y2-side surface of the interior-side main piece 621, and is engageable with and disengageable from the ridged piece 612 of the first transmission member 61. A ridged piece 624 is provided on an exterior Y1-side surface of the exterior-side main piece 623.

The third transmission member 63 includes a strip-shaped mobile piece 631. The mobile piece 631 has a chain-like or belt-like shape, and can move reciprocally in the turning direction C of the crescent body 42 that is turned for locking and unlocking. The mobile piece 631 includes a ridged piece 633 at least on an interior Y2-side surface thereof. The ridged piece 633 of the mobile piece 631 is engageable with and disengageable from the ridged piece 624 provided on the exterior Y1-side of the second transmission member 62.

The ridged piece 612 of the first transmission member 61 and the interior Y2-side ridged piece 622 of the second transmission member 62 have ridges and grooves that are meshed and engaged with each other. Similarly, the exterior Y1-side ridged piece 624 of the second transmission member 62 and the ridged piece 633 of the third transmission member 63 have ridges and grooves that are meshed and engaged with each other.

As shown in FIG. 8, the first transmission member 61 and the second transmission member 62 are engageable with each other via the ridged piece 612 of the first transmission member 61 and the interior Y2-side ridged piece 622 of the second transmission member 62. The second transmission member 62 and the third transmission member 63 are engageable with each other via the exterior Y1-side ridged piece 624 of the second transmission member 62 and the ridged piece 633 of the third transmission member 63.

The second transmission member 62 is arranged such that, when the second transmission member 62 is brought into engagement with the first transmission member 61, the second transmission member 62 is also brought into engagement with the third transmission member 63. In this mutually engaged state, the slide action of the lever 51 in the operation part 50 in the vertical direction Z causes the first transmission member 61 and the second transmission member 62 to slide in the vertical direction Z with the lever 51, and at the same time, the slide action of the second transmission member 62 in the vertical direction Z causes the third transmission member 63 to move in the turning direction C.

Returning to FIG. 2, the first transmission member 61 and the second transmission member 62 are provided on the meeting stiles 302 of the inner window 30. In FIGS. 2 to 4, the first transmission member 61, the second transmission member 62, and the third transmission member 63 are shown in the mutually engaged state, with contours of their meshing ridged pieces being omitted.

The first transmission member 61 is disposed on the exterior Y1-side of the second inner sash 32. The first transmission member 61, engaged with the lever 51, can work integrally with the lever 51 that moves along the slide groove 321. The second inner sash 32 has a recess 322 formed in a facewise, exterior Y1-side surface of the meeting stile 302. The main piece 611 of the first transmission member 61 is placed between the first inner sash 31 and the recess 322.

The second transmission member 62 is provided in the first inner sash 31. The first inner sash 31 has a slide groove 311 that penetrates through the meeting stile 302 between the interior side and the exterior side, and a recess 312 formed in a facewise, interior Y2-side surface of the meeting stile 302. The connecting piece 625 of the second transmission member 62 is placed in the slide groove 311. The interior-side main piece 621 of the second transmission member 62 is placed between the second inner sash 32 and the recess 312. The exterior-side main piece 623 is placed along a facewise, exterior Y1-side surface of the meeting stile 302 of the first inner sash 31.

The third transmission member 63 is disposed at an outer periphery of the crescent body 42 in the locking part 40. The crescent body 42 and the cover 44 are fixed on the meeting stile 202 of the second outer sash 22.

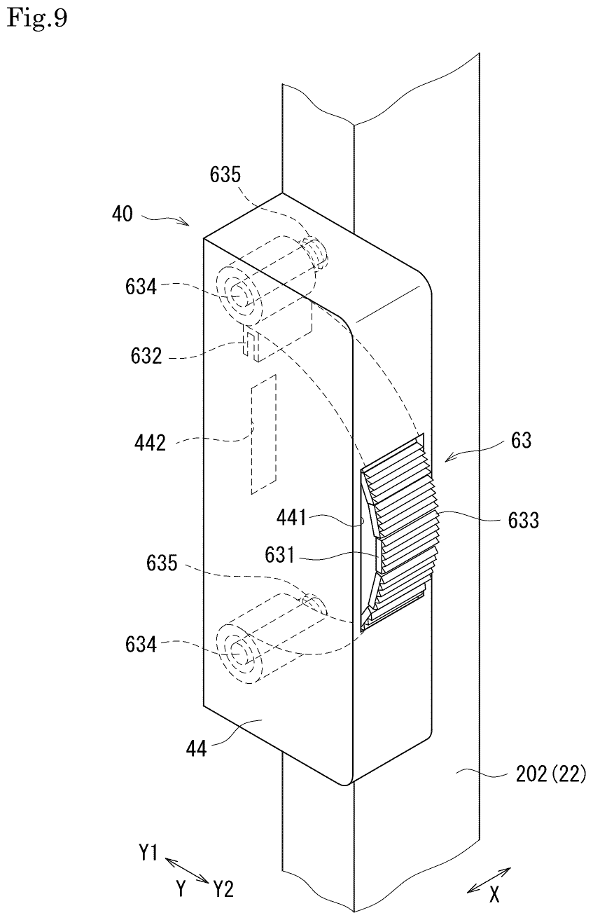

FIG. 9 is an enlarged perspective view of the locking part 40 provided on the meeting stile 202 of the second outer sash 22. The cover 44 has a first opening 441 in an interior Y2-side lateral surface and a second opening 442 in an exterior Y1-side lateral surface. The mobile piece 631 as the third transmission member 63 is arranged to be partially exposed from the first opening 441. In a range of exposure from the first opening 441, the ridged piece 633 of the mobile piece 631 is allowed to mesh and engage with the ridged piece 624 of the second transmission member 62. Further, when the crescent body 42 turns through the second opening 442, the crescent body 42 can engage with the keeper 43 provided on the meeting stile 202 of the first outer sash 21, as shown in FIG. 4.

The mobile piece 631 is equipped with an engagement piece 632 that protrudes, inwardly in a radial direction, from a surface (an inner circumferential surface) that is opposite to the interior Y2-side surface provided with the ridged piece 633. The engagement piece 632 is shaped to have an indented groove that engages with the handle 421 of the crescent body 42. As shown in FIGS. 2 and 3, the engagement piece 632 can hold the handle 421 of the crescent body 42 and can move in the turning direction C with the mobile piece 631.

The mobile piece 631 is a strip-shaped member that is sufficiently longer than the exterior-side main piece 623 of the second transmission member 62. A first end and a second end of the mobile piece 631 are wound up on shafts 634 that are provided one each on an upper part and a lower part inside the cover 44. Each shaft 634 is equipped with a coil spring 635 that urges the mobile piece 631 in a wind-up direction.

As shown in FIG. 2, the cover 44 further encloses a guide member 636 that has a semi-cylindrical curved surface. The guide member 636 is placed along the inner circumferential surface of the mobile piece 631. The mobile piece 631, being guided by the guide member 636, can move reciprocally in the turning direction C of the crescent body 42.

As shown in FIG. 3, when the lever 51 is pressed down and slides downwardly along the slide groove 321, the first transmission member 61 and the second transmission member 62 engaged with the first transmission member 61 are caused to slide downwardly, and the mobile piece 631 engaged with the second transmission member 62 is caused to turn downwardly in the turning direction C. The mobile piece 631 moving in the turning direction C is wound up on the lower shaft 634. The crescent body 42 held by the engagement piece 632 turns in coordination with the mobile piece 631. As a result, the crescent body 42 leaves the keeper 43 and unlocks the crescent lock 41.

Unlocking of the crescent lock 41 enables opening/closing of the outer window 20 and the inner window 30. For example, when the first inner sash 31 of the inner window 30 is opened by sliding from the interior Y2-side, the first outer sash 21 of the outer window 20 is opened coordinately at the same time. On the other hand, when the inner window 30 is closed from an open state, the outer window 20 can be closed coordinately.

As described above, the transmission member 60 is provided across the first inner sash 31, the second inner sash 32, and the second outer sash 22. The linking members 70 enable the first inner sash 31 and the first outer sash 21 to open and close coordinately, and enable the second inner sash 32 and the second outer sash 22 to open and close coordinately. For example, when the first inner sash 31 and the first outer sash 21 are opened and closed by sliding, the first transmission member 61 and the second transmission member 62 slide relative to and separate from each other, as shown in FIG. 5. The second transmission member 62 (the interior Y2-side ridged piece 622) is disengaged from the first transmission member 61 (the ridged piece 612). At the same time, the second transmission member 62 and the mobile piece 631 slide relative to and separate from each other. The second transmission member 62 (the exterior Y1-side ridged piece 624) is disengaged from the mobile piece 631 (the ridged piece 633). The second transmission member 62 provided on the first inner sash 31 moves in the face direction X (in this case, the horizontal direction).

In all of the ridged piece 612 of the first transmission member 61, the ridged pieces 622, 624 of the second transmission member 62, and the ridged piece 633 of the third transmission member 63, the ridges extend parallel to each other in the face direction X, along a slide direction of the outer window 20 and the inner window 30 to be opened and closed by sliding. The ridges and grooves in the ridged pieces 612, 622, 624, 633 may have any shape as far as being capable of meshing and engaging with each other. For example, the ridges and grooves may be composed of a plurality of protrusions or ribs projecting from the surfaces of the main piece 611, the interior-side main piece 621, the exterior-side main piece 623, and the mobile piece 631. In a case where the mobile piece 631 is composed of a chain, a lumpy surface profile of the chain itself may constitute the ridged piece 633.

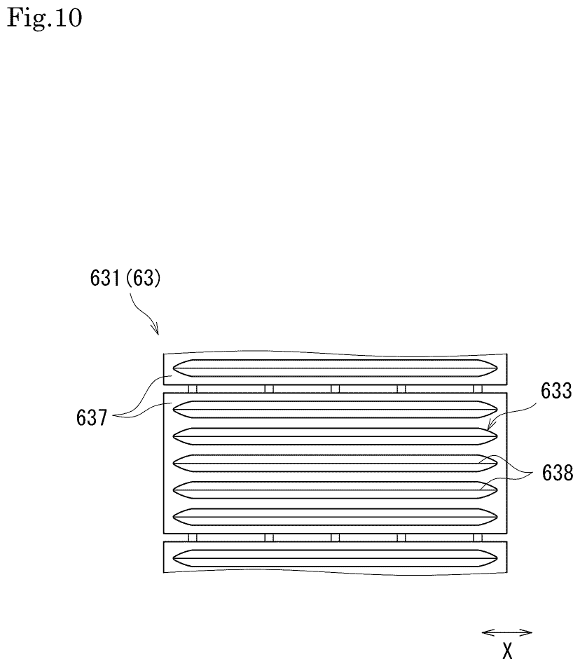

FIG. 10 is a partial enlarged view showing an example of the mobile piece 631 and the ridged piece 633 of the third transmission member 63. For example, the mobile piece 631 may be composed of a chain or the like in which a plurality of flat plate-like split pieces 637 may be joined together in such a manner as to have no gap therebetween when installed on a plane. Each of the split pieces 637 has, on a surface thereof, a plurality of parallel protrusions 638 whose longer sides extend in the face direction X. Each of the protrusions 638 has, for example, a substantially triangular or substantially rectangular cross section.

Preferably, both longitudinal ends in each protrusion 638 have a tapered or wedged shape in which the cross sectional shape gets gradually smaller towards the ends. According to this configuration, each protrusion 638 projects from the surface of the split piece 637 to a lesser degree at both ends thereof, and thus can mesh more easily with the exterior Y1-side ridged piece 624 of the second transmission member 62 that slides in the face direction X. A similar shape is preferable for the ridged piece 624 of the second transmission member 62 that engages with the ridged piece 633 of the mobile piece 631. A similar shape is also preferable for the interior Y2-side ridged piece 622 of the second transmission member 62 and the ridged piece 612 of the first transmission member 61. It is not essential for the protrusions 638 to be continuously elongated in the face direction X. Alternatively, the protrusions 638 may be composed of a plurality of non-continuous protrusions arranged in the face direction X.

When the outer window 20 and the inner window 30 are closed from an open state as shown in FIG. 5 by a slide action of the first inner sash 31 or the second inner sash 32 in the face direction X, the above-described configuration allows the ridged piece 612 of the first transmission member 61 and the interior Y2-side ridged piece 622 of the second transmission member 62 to mesh and engage easily with each other. This configuration simultaneously allows the exterior Y1-side ridged piece 624 of the second transmission member 62 and the ridged piece 633 of the mobile piece 631 to mesh and engage easily with each other. Mutual engagement of the first transmission member 61, the second transmission member 62, and the third transmission member 63, as shown in FIG. 4, enables conversion and transmission of the action of the lever 51 in the slide direction to the action of the crescent body 42 in the turning direction C.

After the crescent lock 41 is locked by the operation of the lever 51, the fixing member 52 provided in the operation part 50 is displaced by sliding and positioned below the lever 51. The fixing member 52 positioned below the lever 51 can hold the lever 51 inoperably and can keep the crescent lock 41 locked. This configuration enables double locking by the locking part 40 in the outer window 20 and the fixing member 52 in the inner window 30.

As described above, regarding a double window having an inner window and an outer window, it is troublesome to open the outer window equipped with a crescent lock. Conventionally, it is impossible to unlock the crescent lock and to open the outer window, unless an inner window sash is opened maximally so as to enable a turning operation of a crescent body on the outer window. Since the crescent body is normally provided on one of the depthwise surfaces of the meeting stiles, it is required to open the inner window sash maximally on a proper side, namely, on a side that can expose the depthwise surface equipped with the crescent body. If an inner window sash on a wrong side is opened, as it sometimes happens, a person fails to expose the crescent body and has to open the inner window sash on the other side again. Similarly, in order to close and lock the outer window, it is essential to keep the inner window sash open maximally; otherwise, it is impossible to turn the crescent body on the outer window and thereby to lock the outer window.

In contrast, in the double window 10 that includes the window structure according to the present disclosure, it is possible to unlock the crescent lock 41 in the outer window 20 and to make the outer window 20 openable, simply by operating the lever 51 in the inner window 30 from the interior Y2-side. Besides, the window structure that enables coordinated opening/closing of the inner window 30 and the outer window 20 remarkably simplifies the opening/closing operation of the windows. With the crescent lock 41 being unlocked, opening of a desired sash of the inner window 30 (the first inner sash 31 or the second inner sash 32) causes simultaneous opening of the outer window 20. The locking part 40, equipped with the cover 44 that covers the crescent body 42 and the like, is less visible from outside and is advantageous also in terms of security.

In the above-described configuration, the operation part 50 for the crescent lock 41 is composed of the slidably operable lever 51, but the window structure according to the present disclosure is not limited thereto. As the operation part 50, the lever 51 may be replaced with a rotatable roller, for example. In this case, a ridged piece engageable with and disengageable from the transmission member 60 may be arranged on an outer circumferential surface of the roller, such that an action of the roller in a rotation direction can be transmitted to the crescent body 42 via the transmission member 60.

In the window structure according to the present disclosure, the outer window 20 includes at least the first outer sash 21 and the second outer sash 22 that are slidable relative to each other, and the inner window 30 includes at least the first inner sash 31 and the second inner sash 32 that are slidable relative to each other. As far as these requirements are satisfied, the window structure is not limited to the two-sash horizontal sliding window as exemplified herein. The window structure according to the present disclosure is also applicable to windows for various purposes such as for daylighting, draft, air ventilation, and various types of opening in a building such as a French window (a casement door) for allowing entry and exit of people.

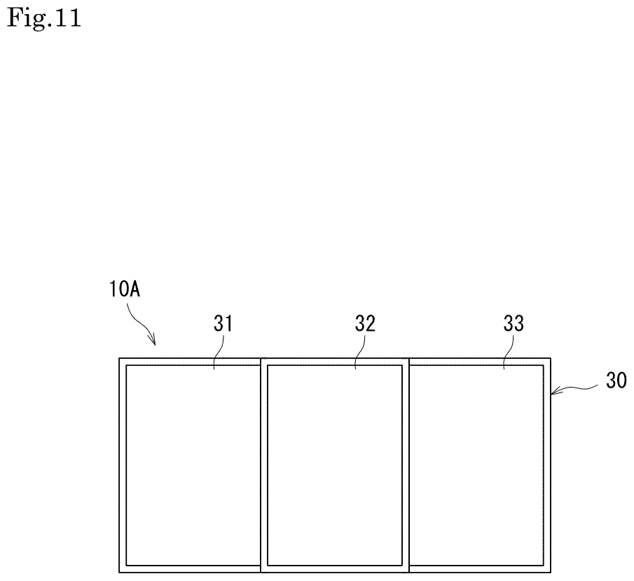

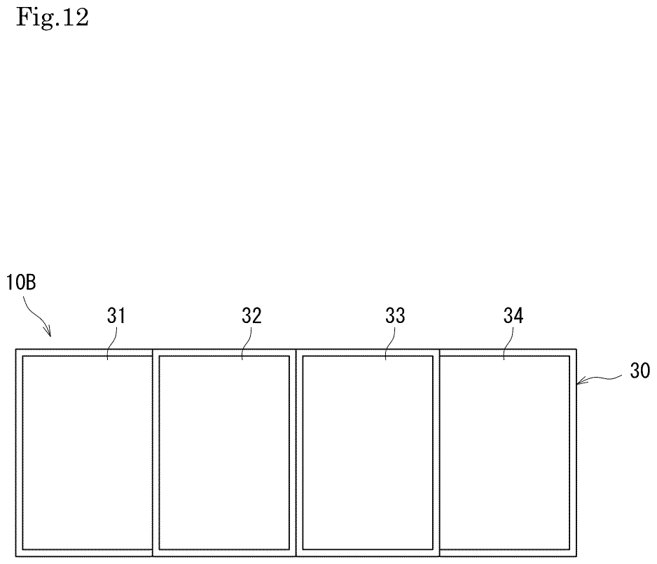

The window structure according to the present disclosure is further applicable to single horizontal sliding windows and center-opening horizontal sliding windows. The opening/closing direction is not limited to the horizontal direction but may be the vertical direction. The number of sashes constituting the outer window 20 and the inner window 30 is not limited to the example mentioned in this disclosure. For example, the window structure may include three sashes as shown in FIG. 11, wherein the inner window 30 of a double window 10A includes a first inner sash 31, a second inner sash 32, and a third inner sash 33. Alternatively, the window structure may include four sashes as shown in FIG. 12, wherein the inner window 30 of a double window 10B includes a first inner sash 31, a second inner sash 32, a third inner sash 33, and a fourth inner sash 34. Additionally, the outer window 20 and the inner window 30 may include a fixed sash.

The above-described embodiment is considered in all respects as illustrative and not to be a basis for restrictive interpretation. Therefore, the technical scope of the present disclosure is not interpreted by the above-described embodiment only, but is rather determined on a basis of the appended claims.

### DESCRIPTION OF THE REFERENCE NUMERALS

10 double window
20 outer window
21 first outer sash
22 second outer sash
30 inner window
31 first inner sash
32 second inner sash
202, 302 meeting stile
41 crescent lock
42 crescent body
421 handle
44 cover
50 operation part
51 lever
60 transmission member
61 first transmission member
62 second transmission member
63 third transmission member
612, 622, 624, 633 ridged piece
631 mobile piece
632 engagement piece
636 guide member
70 linking member

1. A window structure comprising:
an outer window comprising outer sashes to be opened and closed by sliding; and
an inner window comprising inner sashes to be opened and closed by sliding, the inner window being disposed on an interior side of the outer window,
wherein
the outer window is provided with a crescent lock that locks the outer sashes unopenably, the crescent lock comprising a crescent body that is capable of turning and that is provided on a meeting stile of one of the outer sashes,
the inner window is provided with an operation part that causes the crescent body to turn and that is provided on a meeting stile of one of the inner sashes opposed to the crescent body, and
a transmission member configured to transmit an action of the operation part to the crescent body is provided between the crescent body and the operation part.

2. The window structure according to claim 1, wherein
each of the outer sashes and an opposed one of the inner sashes disposed on an interior side of the outer sashes are linked via a linking member, and each of the outer sashes can slide in coordination with opening and closing of the opposed inner sash.

3. The window structure according to claim 1, wherein
the outer sashes comprise at least a first outer sash and a second outer sash that are disposed slidably relative to each other, the first outer sash and the second outer sash overlapping with each other at a meeting stile of the first outer sash and a meeting stile of the second outer sash, and the crescent lock is provided across the meeting stiles of the first and second outer sashes, and
the inner sashes comprise at least a first inner sash and a second inner sash that are disposed slidably relative to each other, the first inner sash and a second inner sash overlapping with each other at a meeting stile of the first inner sash and a meeting stile of the second inner sash, and the operation part is provided on one of the meeting stiles of the first and second inner sashes.

4. The window structure according to claim 1, wherein
the operation part comprises a slidably operable lever that is exposed to an interior side of the inner sashes, and
the transmission member converts and transmits an action of the lever in a slide direction to an action of the crescent body in a turning direction.

5. The window structure according to claim 4, wherein
the transmission member comprises:
a first transmission member that works integrally with the lever;
a second transmission member engageable with and disengageable from the first transmission member; and
a third transmission member that is connected to the crescent body and that can move reciprocally in the turning direction of the crescent body,
wherein
the second transmission member is also engageable with and disengageable from the third transmission member, and
when the second transmission member is brought into engagement with the first transmission member, the second transmission member is also brought into engagement with the third transmission member.

6. The window structure according to claim 5, wherein
the first transmission member and the second transmission member are provided across meeting stiles of the inner sashes, and
the third transmission member is provided on the meeting stile of the one of the outer sashes.

7. The window structure according to claim 5, wherein
each of the first transmission member and the second transmission member comprises a plate-shaped main piece that is accommodated between meeting stiles of the inner sashes.

8. The window structure according to claim 5, wherein
the third transmission member comprises a strip-shaped, chain-like or belt-like mobile piece, and a guide member that guides the mobile piece in the turning direction of the crescent body.

9. The window structure according to claim 8, wherein
the mobile piece comprises an engagement piece that is engaged with a handle of the crescent body and thereby holds the handle.

10. The window structure according to claim 5, wherein
the first transmission member comprises a ridged piece,
the second transmission member comprises a ridged piece, and
the ridged pieces of the first transmission member and the second transmission member are configured to mesh and engage with each other.

11. The window structure according to claim 5, wherein
the second transmission member comprises a ridged piece,
the third transmission member comprises a ridged piece, and
the ridged pieces of the second transmission member and the third transmission member are configured to mesh and engage with each other.

12. The window structure according to any one of claims 1 to 11, wherein
the outer window comprises a cover that covers at least the crescent lock.
